(19) United States
(12) Patent Application Publication
(10) Pub. No.: US 2023/0049594 A1
(43) Pub. Date: Feb. 16, 2023

(54) FLUID DISPENSER COMPRISING REFILLABLE DISPOSABLE BAG AND A MEANS FOR FLOW CONTROL

(71) Applicant: Peter Gombrich, Salinas, CA (US)

(72) Inventor: Peter Gombrich, Salinas, CA (US)

(21) Appl. No.: 17/402,498

(22) Filed: Aug. 13, 2021

(51) Int. Cl. B65D 83/00; B01F 13/00

(52) U.S. Cl. CPC B65D 83/0072; B01F 13/0052; B01F 13/0027; B01F 2215/005

(57) ABSTRACT

In one aspect, the invention provides a fluid dispenser comprising a housing configured to receive a means for pressurizing and a disposable fluid bag, and a nozzle towards a distal end. A means for flow control comprising a tubular body whose longitudinal axis coincides with the longitudinal axis of the nozzle having a diameter that tapers from the side distal to the nozzle towards the nozzle is provided. The tubular body is configured to move along its longitudinal axis such that a volume of a gap between the tubular body and the nozzle is varied thus controlling the flow rate. Further, an adapter configured to be fitted onto the nozzle capable of receiving at least one applicator is provided. The fluid dispenser of the invention is capable of being used in a variety of situations in a facile manner, replacing several different devices to be used for individual applications.

### TECHNICAL FIELD OF THE INVENTION

The invention relates generally to a fluid dispenser and more specifically to a fluid dispenser that comprises a refillable disposable bag capable of controlling flow and being reused for a variety of different types of fluids such as paint, putty and so on.

### BACKGROUND

Home improvement projects encompass a wide variety of activities ranging from painting walls and ceilings to filling holes in walls left behind by old hangings, and many such activities. For each type of activity, a unique assembly or kit is made available to enable it. For example, a paint job requires a paint brush and the paint in the form of an emulsion in a suitable container, while a putty is needed to fill small holes in walls from the use of nails or screws to hang art or photographs. Putty is typically applied using a suitable applicator that enables filling of the holes and smoothening the surface to make it appear flush against the rest of the wall. Similarly, cracks in woodwork are filled using resin, which is then allowed to harden. On many occasions, adhesives are applied in the same manner.

Thus, a typical storage space in a home such as a garage or a closet is filled with equipment and kits that have been used once and generally are not used again. Most of the equipment and kits take up considerable space. They are also inconvenient to transport to a use location whenever required.

In a general sense, all the applications involve a very similar principle of taking a fluid formulation in a container then dispensing it onto a surface through an orifice and spreading the formulation onto a surface using a specific applicator designed for the purpose. The variations between different applications involve the flow characteristics of the fluid formulation, the rate at which the fluid is allowed to flow through the orifice, the geometry of the applicator in use, volume of the fluid formulation required for the purpose, and so on.

Hence it can be seen that there are similarities in the requirements of various types of applications, and some differences between them too. It would be convenient to have a simpler kit that allows for interchangeable parts such that the main unit can be used for all different activities, while some interchangeable parts specific to a particular type of application that is capable of being assembled suitably when in use, and can be disassembled and stored, or disposed of in a suitable manner.

### SUMMARY OF INVENTION

In one aspect, the invention provides a fluid dispenser that comprises a housing that can receive a means for pressurizing and a disposable fluid bag that can be positioned inside the means for pressurizing. Once the disposable fluid bag is filled with a suitable fluid, pressure is exerted onto it to evacuate any air and allow the fluid to flow through a nozzle, via a means for flow controller. After use, the disposable fluid bag can be reused by refilling the fluid or may be disposed of in a suitable manner. The fluid dispenser further comprises an adapter that is configured to be fitted onto the nozzle, and is further configured to receive at least one applicator.

In another aspect, the invention provides a method for dispensing fluid from the fluid dispenser of the invention. The method comprises filling the disposable fluid bag with the fluid of choice and loading it into the housing that comprises the means for pressurizing. Then the method includes exerting pressure onto the disposable fluid bag to expel any air and allowing the fluid to flow through the nozzle. The method then involves setting a flow rate of the fluid using the means for flow controller to a predetermined level, following which the fluid is allowed to flow through the nozzle via an adapter and through the applicator at a desired flow rate.

### DRAWINGS

These and other features, aspects, and advantages of the present invention will become better understood when the following detailed description is read with reference to the accompanying drawings in which like characters represent like parts throughout the drawings, wherein:

FIG. 1 shows a fluid dispenser of the invention, wherein the means for pressurizing comprises a diaphragm.

FIG. 2 shows a fluid dispenser of the invention wherein the means for pressurizing comprises a compression slide.

FIG. 3 shows a means for flow controller used in the fluid dispenser of the invention.

FIG. 4A shows the use of means for flow controller to allow flow of fluid.

FIG. 4B shows the use of means for flow controller to stop flow of the fluid.

FIG. 5A shows a paint brush used as the applicator to be used with the fluid dispenser of the invention.

FIG. 5B shows a roller used as the applicator to be used with the fluid dispenser of the invention.

FIG. 5C shows a spray can used as the applicator to be used with the fluid dispenser of the invention.

FIG. 5D shows a pad used as the applicator to be used with the fluid dispenser of the invention.

FIG. 6A shows a housing having an opening and another distal end opening.

FIG. 6B shows the nozzle and the means for flow control fitted onto the disposable fluid bag.

FIG. 6C shows an assembly comprising the disposable fluid bag.

### DETAILED DESCRIPTION

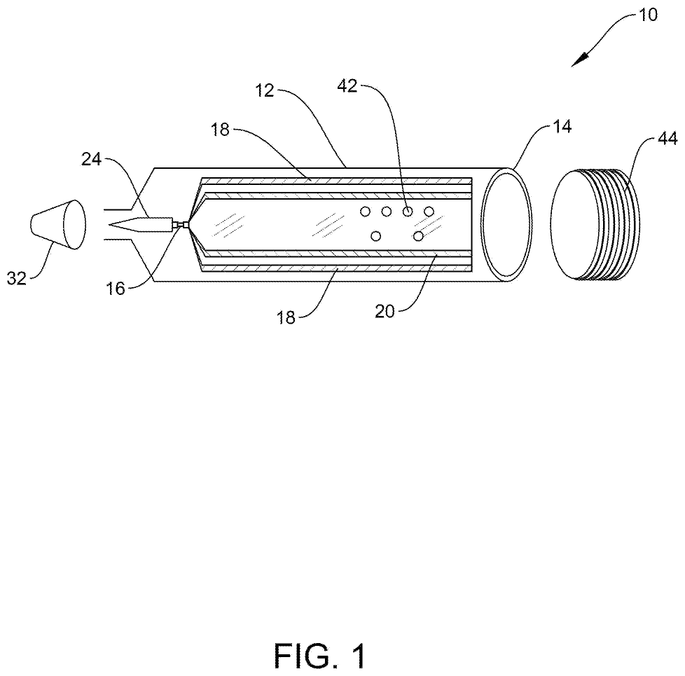

As noted herein, in one aspect the invention provides a fluid dispenser. Turning to drawings, FIG. 1 shows the fluid dispenser 10. The fluid dispenser comprises a housing 12 that is typically rigid, which comprises an opening 14 and a nozzle 16 at a distal end from the opening, wherein the nozzle is characterized by a longitudinal axis. The housing 12 is capable of receiving a means for pressurizing. In one embodiment, the means for pressurizing is a diaphragm 18. The fluid dispenser 10 then comprises a disposable fluid bag 20 that is configured to be removably via by the diaphragm 18. The diaphragm 18 is capable of exerting pressure on the disposable fluid bag 20 that will cause fluid present inside the disposable fluid bag 20 to be expelled through a bag opening 22. The pressure is exerted by a suitable actuation means, which may include, for example, hydraulic means, electronic means, mechanical means, and the like.

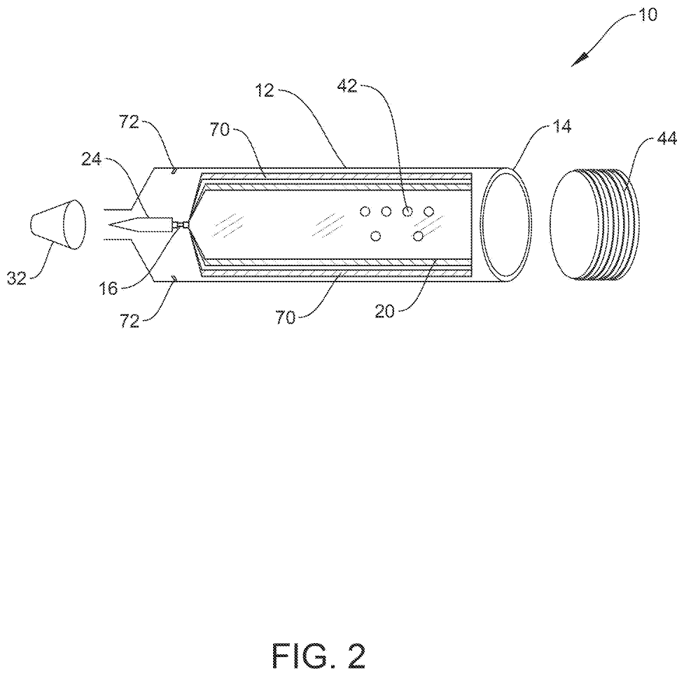

In another embodiment, the means for pressurizing is by means of a compression slide. FIG. 2 shows the fluid dispenser 10 having a compression slide 70, which is configured to push onto the disposable fluid bag 20. In this manner, any trapped air can be removed and the disposable fluid bag 20 can be pressurized. The compression slide may be provided on the inside portion of the housing 12 designed to receive the disposable fluid bag. Further, the inside portion of the housing may comprise grooves to receive the compression slide, which may also include a suitable notch 72 or other means to lock (not shown) the compression slide in its location. Similarly, appropriate means for unlocking and removal of the compression slide may also be provided. In yet another embodiment, the means for pressurizing comprises a plunger (not shown).

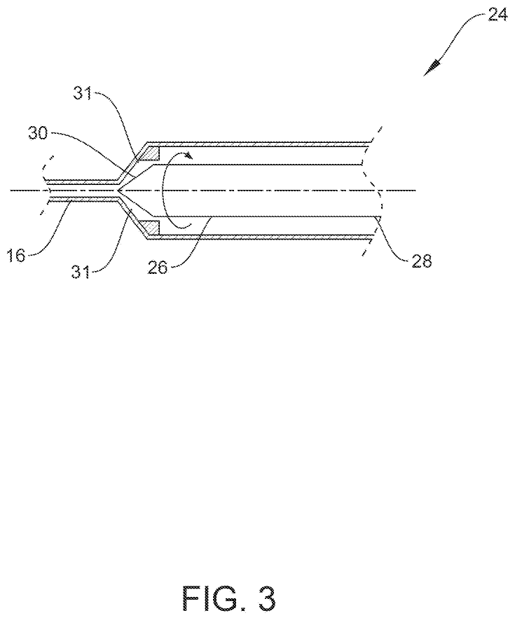

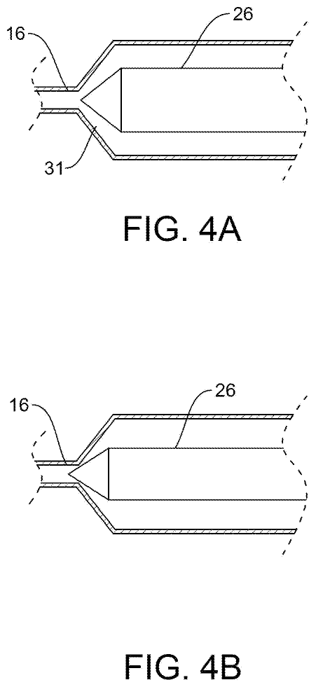

The fluid dispenser 10 further comprises a means for flow control 24. FIG. 3 shows one exemplary embodiment of the means for flow control 24 that comprises a tubular body 26 having its longitudinal axis parallel to the longitudinal axis of the nozzle '16, wherein the tubular body 26 is capable of rotating along a rotational axis that coincides with it longitudinal axis. The tubular body 26 has a backend 28 distal to the nozzle 16 and a front end 30 proximal to the nozzle 16, wherein the diameter of the tubular body 26 reduces from the backend to the front end. The tubular body 26 is capable of traversing along its longitudinal axis as it rotates. The tubular body is also configured to be held in a certain position along its length such that a space 31 is defined between the tubular body 26 and the nozzle 16 through which the fluid is allowed to flow. Further, the diameter of the tubular body towards the back end is configured to be greater than the diameter of the nozzle 16 such that when the tubular body 26 comes into contact with the nozzle 16, it forms a seal that will not allow flow of fluids through the nozzle 16. By controlling the size of the gap 31 by opening and closing the nozzle 16 using the tubular body 26, flow rate for a fluid can be controlled. FIG. 4A shows the presence of a gap 31 between the nozzle 16 and the tubular body 26, while FIG. 4B shows the gap between the tubular body 26 and the nozzle 16 sealed off.

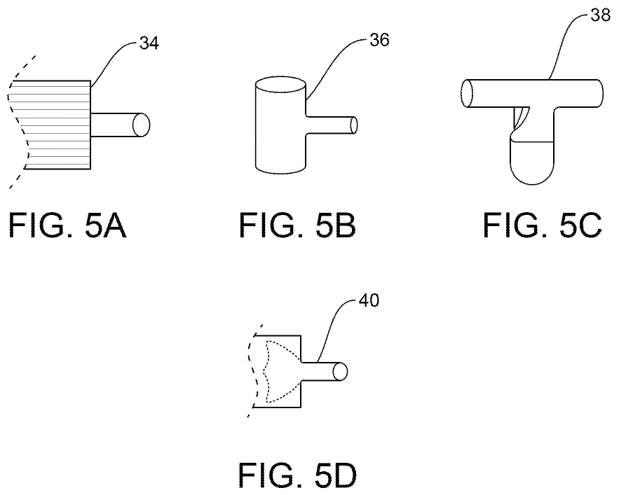

Returning to FIG. 1, the fluid dispenser 10 then comprises an adapter 32 configured to be received by the nozzle 16. The adapter 32 is further configured to removably receive at least one applicator. FIGS. 5A-5D shows different applicators useful in the invention, which may include, for example, FIG. 5A shows a paint brush 34, while FIG. 5B shows a roller 36, FIG. 5C shows a spray can 38, and FIG. 5D shows a pad 40. Other such applicators are also known in the art and may be used with the fluid dispenser 10 of the invention without too much experimentation by one skilled in the art, and are all contemplated to be within the scope of the invention. Means for attaching the applicator to the adapter are well known in the art, and may include, for example, threaded screws, snap-fit, Luer lock, and the like. Thus, by enabling the ability to attach multiple dispensing heads, the characteristics of the surface to which the fluid (such as paint, etc) are dispensed onto the surface onto which the fluid needs to be applied can be matched to a great extent.

The disposable fluid bag 20 further includes mixing means 42 in FIG. 1 and FIG. 2. Exemplary mixing means useful in the invention include beads, for example.

In a typical use case scenario, the disposable fluid bag 20 is filled with an appropriate fluid and then loaded into the fluid dispenser 10 through the opening 14. Useful fluids in the invention include paint, glue, gypsum plaster, and the like. It will become obvious to one of ordinary skill in the art that the disposable fluid bag may be filled with the same fluid (such as a paint or a stain etc.), as the original fluid, thus ensuring a perfect match with the original surface finish. In an alternate embodiment, the disposable fluid bag 20 is loaded into the fluid dispenser 10, and then filled with the appropriate fluid. Methods for filling fluids into the disposable fluid bag are known, and may include, for example, injecting the fluid into the bag, pouring the fluid, using suction under pressure, and the like. In one specific embodiment, a bulb is used to suck the appropriate fluid into the disposable fluid bag 20. The bulb may be configured to open the means for flow control to a suitable extent such that it allows for pressure normalization to allow for fluid to flow into the disposable fluid bag 20. Subsequently, the compression slide is used to pressurize the disposable fluid bag 20 such that it removes any trapped air from inside the disposable fluid. In some embodiments, the disposable fluid bag 20 may be used to store the fluid. The storage can be done after evacuation and sealing of the disposable fluid bag 20.

Once the disposable fluid bag 20 is loaded into the fluid dispenser 10, the opening 14 is sealed off using, for example a cap 44. Then, the means for flow control is rotated to set the gap at a suitable level to ensure proper flow rate of the fluid. Then, the diaphragm 18 is used to exert pressure on the disposable fluid bag 20 so that all air trapped inside the disposable fluid bag 20 is expelled through the nozzle. Once the fluid starts oozing out of the nozzle, it can be safely assumed that all the air is expelled, and the disposable fluid bag is fully pressurized. The fluid dispenser 10 may also be configured such that the nozzle is sealed off but can be unsealed by a suitable attachment on the adapter and/or the applicator. In this manner, the fluid is not wasted but maintained at a pressurized state inside the disposable fluid bag until the applicator is attached and is ready to dispense the fluid onto a suitable surface. At this point, the flow rate can be experimented with to optimize the flow for the purpose on hand. For example, to paint an entire wall of a room that may measure 12 feet by 12 feet, a high flow rate can be provided, whereas to fill small holes on the wall due to removal of hangings etc. slower flow rates would be required. The viscosity of the fluid may also play a role in determining the flow rate. The diaphragm 18 is then actuated to apply a suitable pressure that then allows for the fluid to flow smoothly through the nozzle. At any point, the user can stop the activity by relieving the pressure on the disposable bag or by closing off the nozzle using the means for flow control and can then resume it after the break.

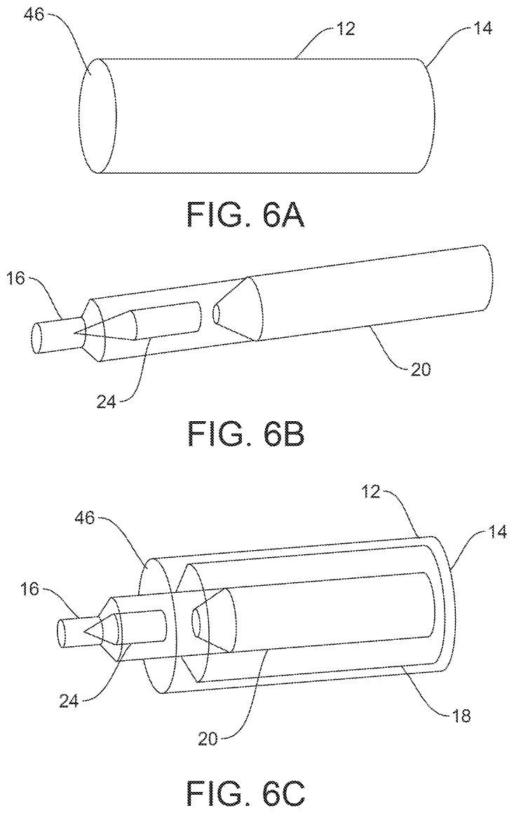

In some embodiments, the nozzle 16 comprises the means for flow control 24, which is then configured to fit into the disposable fluid bag 20. Once this part is assembled, it may be fitted onto the housing 12 such that the nozzle is allowed to jut out of the housing through a distal end orifice. FIG. 6A shows a housing 12 having the opening 14 and an opening 46 distal from the opening 14. FIG. 6B shows the nozzle 16 and the means for flow control 24 fitted onto the disposable fluid bag 20. FIG. 6C shows an assembly comprising the disposable fluid bag 20 fitted with the nozzle 16 and the means for flow control 24 held within the diaphragm 18 and the housing such that the nozzle protrudes out of the distal end opening 46.

Thus, using the means for flow control 24, the flow can be varied according to various factors, such as, but not limited to, viscosity of the materials being dispensed, characteristics of the adapter, characteristics of the applicator, and the like, and combinations thereof

The fluid dispenser 10 provides a tremendous advantage in that the same dispenser can be used for multiple uses such as paint jobs, filling putty, gluing joints, and so on. One only needs to replace the disposable fluid bag with another disposable fluid bag for a different purpose. The disposable fluid bag can also be pre-filled and stored with a suitable fluid of choice. It also further enables sealing off of prefilled disposable fluid bags that is capable of being used with the fluid dispenser of the invention. The replacement of the disposable fluid bag can be achieved in a facile manner by anyone without too much effort. In this manner, contamination between different kinds of fluids can easily be avoided. The disposable fluid bag can then be stored for later use or can be disposed of in a suitable manner. Further, after the completion of a project (for example, once a room has been painted), any remaining fluid in the nozzle and the applicator may be sucked back into the compression slide through appropriate means. This ensures there is no wastage of fluid, as well as facilitating cleaning of the nozzle and applicator.

The fluid dispenser 10 also provides a further advantage of not being limited to the volume of the fluid to be used in the disposable fluid bag. Hence, the same fluid dispenser can be used for a very small volume of fluid as well as for a large volume of fluid. This is enabled using a suitable means for pressurizing that can exert an appropriate amount of pressure on the disposable fluid bag appropriately.

The disposable fluid bag, the adapter, and the applicators may be made disposable. Alternately, they can be stored and reused later for a similar purpose. It can be understood that if the disposable fluid bag is used to paint a wall with blue paint, then it almost necessitates it being used for the same purpose and for the same color as well. Use of any other color might result in contamination leading to unpleasant consequences. Further, cleaning of these bags is not feasible due to the nature of the fluid in use. Hence, disposing of the bag is quite often the most feasible solution. Similarly, different adapters may find use in different situations, all of which may be designed to be disposable. All these disadvantages can be overcome in a facile manner when the fluid dispenser of the invention including the requisite components is used appropriately.

While only certain features of the invention have been illustrated and described herein, many modifications and changes will occur to those skilled in the art. It is, therefore, to be understood that the appended claims are intended to cover all such modifications and changes as fall within the true spirit of the invention.

The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the term “or” is generally employed in its sense including “and/or” unless the content clearly dictates otherwise.

1. A fluid dispenser comprising:
a housing having an opening and a nozzle at a distal end from the opening, wherein the housing is configured to receive a disposable fluid bag and a means for pressurizing the disposable fluid bag, wherein the disposable fluid bag comprises a bag opening leading into the nozzle, wherein the means for pressurizing comprises at least one of a diaphragm located inside the housing configured to receive the disposable fluid bag and capable of exerting pressure on the disposable fluid bag such that it forces fluid out through the bag opening, a compression slide configured to push onto the disposable fluid bag, or a plunger;
a means for flow control adjacent to the distal end, wherein the mean for flow control comprises a tubular body capable of rotation having a back end distal from the nozzle and a front end proximal to the nozzle, wherein the tubular body has a tapering diameter that reduces in diameter from the back end to the front end; and
an adapter configured to be connected to the nozzle that is capable of receiving at least one type of applicator.

2. The fluid dispenser of claim 1 wherein the disposable fluid bag further comprises a means for mixing.

3. The fluid dispenser of claim 2 wherein the means for mixing comprises beads.

4. The fluid dispenser of claim 1 wherein the fluid is at least one of a paint, glue, putty.

5. The fluid dispenser of claim 1 wherein the applicator is selected from a group comprising a paint brush, a spray can, a pad, or a paint roller.

6. A method for dispensing fluid comprising:
providing a fluid dispenser, wherein the fluid dispenser comprises:
a housing having an opening and a nozzle at a distal end from the opening, wherein
the housing is configured to receive a disposable fluid bag and a means for pressurizing the disposable fluid bag, wherein the disposable fluid bag comprises a bag opening leading into the nozzle, wherein the means for pressurizing comprises at least one of a diaphragm located inside the housing configured to receive the disposable fluid bag and capable of exerting pressure on the disposable fluid bag such that it forces fluid out through the bag opening, a compression slide configured to push onto the disposable fluid bag, or a plunger,
a means for flow control adjacent to the distal end, wherein the means for flow control comprises a tubular body capable of rotation having a back end distal from the nozzle and a front end proximal to the nozzle, wherein the tubular body has a tapering diameter that reduces in diameter from the back end to the front end, and
an adapter configured to be connected to the nozzle that is capable of receiving at least one applicator,
performing at least one of filling the disposable fluid bag with the fluid and loading the disposable fluid bag into the housing or loading the disposable fluid bag into the housing and filling it with the fluid;
pressurizing the disposable fluid bag to allow flow of the fluid through the flow;
actuating the means for flow controller to a predetermined rate of flow; and
dispensing the fluid through the nozzle into the adapter and at least one applicator.

7. The method of claim 6 wherein the disposable fluid bag further comprising mixing means.

8. The method of claim 7 wherein the mixing means comprises beads.

9. The method of claim 6 wherein the applicator is selected from a group comprising a paint brush, a spray can, a pad, or a paint roller.

10. The method of claim 6 wherein the fluid is at least one of a paint, glue, putty.
